(19) United States
(12) Patent Application Publication
(10) Pub. No.: US 2026/0178525 A1
(43) Pub. Date: Jun. 25, 2026

(54) HIGH-BANDWIDTH CHIPLET INTERCONNECTS

(71) Applicant: MaxLinear, Inc., Carlsbad, CA (US)

(72) Inventor: Curtis Ling, Carlsbad, CA (US)

(73) Assignee: MaxLinear, Inc., Carlsbad, CA (US)

(21) Appl. No.: 19/428,044

(22) Filed: Dec. 19, 2025

Related U.S. Application Data
(60) Provisional application No. 63/736,546, filed on Dec. 19, 2024.

(51) Int. Cl. G06F 13/38; G06F 13/42; H04L 25/03; H04L 25/08

(52) U.S. Cl. CPC G06F 13/385; G06F 13/4286; H04L 25/03; H04L 25/085

(57) ABSTRACT

A device may include a die-to-die (D2D) interconnect. The D2D interconnect may receive first data at a first port and transmit second data from a second port. One or more of a voltage or a bias of the D2D interconnect may be dynamically adapted based on target link performance.

### RELATED APPLICATION

This application claims the benefit of U.S. Provisional Application No. 63/736,546, filed Dec. 19, 2024, the disclosure of which is incorporated herein by reference in its entirety.

The examples discussed in the present disclosure are related to high-bandwidth chiplet interconnects.

### BACKGROUND

Unless otherwise indicated herein, the materials described herein are not prior art to the claims in the present application and are not admitted to be prior art by inclusion in this section.

Datacenter scale-up networks such as ultra accelerator link (UALink®) may use interposer-free chiplet technologies. The interposer-free chiplet technologies may provide wire abundance and physical scale. Devices and methods for using interposer-free chiplet technologies in datacenters may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A device may include a die-to-die (D2D) interconnect. The D2D interconnect may receive first data at a first port and transmit second data from a second port. One or more of a voltage or a bias of the D2D interconnect may be dynamically adapted based on target link performance.

A method may include receiving, at a die-to-die interconnect, first data at a first port. The method may include sending, from the D2D interconnect, second data from a second port. The method may include adapting dynamically one or more of a voltage or a bias of the D2D interconnect based on target link performance.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example compliance eye mask.

FIG. 2A illustrates an example optical eye diagram.

FIG. 2B illustrates an example optical eye diagram.

FIG. 3 illustrates a process flow for a die-to-die (D2D) interconnect.

FIG. 4 illustrates a block diagram of an example system for a D2D interconnect.

FIG. 5 illustrates a diagrammatic representation of a machine in the example form of a computing device within which a set of instructions, for causing the machine to perform any one or more of the methods discussed herein, may be executed.

### DESCRIPTION

The wire abundance and physical scale provided by interposer-free chiplet technologies may be high-throughput/low-latency inline compression for datacenter scale-up networks such as ultra accelerator link (UALink®). Due to their size (which may be substantially larger than existing interposers), systems which leverage board-scale chiplet (BSC) technology may implement a wide variety of link types with different reaches, throughput targets, density targets, and efficiency targets. A framework for BSC physical layer (PHY) may implement this wide variety of link types.

The physical layer of the die-to-die (D2D) interconnect may involve several factors including: (1) facilitating a wide range of reaches, (2) facilitating algorithmic complexity tradeoffs, (3) leveraging adaptability, (4) facilitating link flexibility, (5) facilitating dynamic voltage and/or bias scaling, (6) leveraging link training (e.g., foreground and background), (7) facilitating duty cycling for energy efficiency at different rates, (8) facilitating modulation as a tradeoff, and/or (9) supporting different wiring configurations.

A device may include a D2D interconnect that may receive first data at a first port and transmit second data from a second port. The device may have several characteristics related to the factors provided. For example, one or more of a voltage or a bias of the D2D interconnect may be dynamically adapted based on target link performance.

A wide range of reaches may be implemented. For example, a link reach of the D2D interconnect may be from about 100 μm to about 50 cm. For purposes of this disclosure, “about” may be an amount that is within less than one or more of 10%, 5%, 4%, 3%, 2%, or 1% of an amount. Because low-loss BSC interconnects may be facilitated, a range of chiplet interconnect capabilities may be used to address link reaches spanning 100 um to 50 cm without a sharp boundary between different reach domains. Many chiplet standards have focused on short reach D2D which would not be suitable for this purpose. Implementing this range of links (e.g., 100 μm to about 50 cm) within a single framework may simplify and/or standardize the task of architecting and designing systems leveraging BSC. To facilitate longer reaches, higher voltage swings and/or increased equalization may be used.

The D2D interconnect may be used with various standards. For example, one or more of a UALink® standard, an advanced interface bus (AIB) standard, or a high bandwidth memory 3 (HBM3) standard may be used in conjunction with a D2D standard such as a universal chiplet interconnect express (UCIe) standard. In addition or alternatively, the D2D interconnect may facilitate a BSC and energy optimized alternative.

The D2D interconnect may facilitate algorithmic complexity tradeoffs. Process node speeds may not be enhanced over time, but density and energy efficiency may continue to scale. The D2D interconnect may maximize one or more of energy efficiency, beachfront density, or throughput density. A combination of analog and digital signal processing may be balanced against energy efficiency, beachfront density, and throughput density. Enhancements in process density and power efficiency may be used to adapt transceiver complexity to the challenges of each channel.

The D2D interconnect may leverage adaptability. For example, an eye mask of the D2D interconnect may be based on one or more of error correction, latency, or energy efficiency. There may not be a fixed specification for the eye mask and/or link reach. Rather, the link may establish an eye mask contingent on several factors such as: (a) the bit error rate (BER) target and/or the amount of error correction in the link, (b) whether the link is differential or single ended, (c) the symbol timing capability available in each link, and/or (d) the assessments of channel impairments present in the link. These factors may facilitate the reach potential of low-loss build-up organics that may be implemented which may permit longer reaches than other substrate types. For example reaches of up to about 50 cm may be permitted. The link may be capable of adapting to substrates exhibiting worse loss characteristics. Eye masks may adapt depending on whether the use case elects error correction, focuses on minimum latency, or prioritizes energy efficiency. In addition or alternatively, eye masks may adapt based on the channel itself.

The D2D interconnect may implement link flexibility. The link capability of the D2D interconnect may be determined using one or more of sensing or handshaking. The link capability may be determined at different times. For example, the link capability may be determined at design time. The link complexity may be established based on foreseeable use cases and/or product level targets. Alternatively or in addition, the link capability may be determined at back-end-of-line (BEOL) time. The link complexity and energy efficiency and speed may be adapted for an assembly with hardwiring. Alternatively or in addition, the link capability may be determined at run time. Chiplets having flexible use cases may be configured by firmware by sensing and/or handshaking mechanisms, or at the outset.

The D2D interconnect may implement dynamic voltage and bias scaling. One or more of a voltage or a bias of the D2D interconnect may be dynamically adapted based on target link performance. For example, frame error rates, in a manner similar to dynamic voltage scaling (DVS) used in advanced application specific integrated circuits (ASICs), may be a target link performance. Flexible tradeoffs may autonomously be made between reach and energy efficiency. Some links may include error correction capability, and the link adaptation may account for forward error correction (FEC) power to find a power-optimal performance as well as virtually error-free performance. A single on-chip dynamic voltage scaling controller may be employed together with link adaptation feedback to scale the voltage across a group of links. One end of the link may be designated during design time (via firmware (FW) configuration or hardwiring) to supply rails for a given group of links.

In conjunction with dynamic voltage scaling and bias scaling, the D2D interconnect may implement continuous and/or periodic eye monitoring adaptive equalization. The supply voltage may be adjusted based on feedback, e.g., eye monitoring adaptive equalization. For example, for two dies that are in proximity to each other and communicating using e.g., UCIe, an adaptive mechanism may be used to lower the supply voltage. The supply voltage may be dropped on an interface by interface basis. Chips may be scaled independently or in combination. Thus, feedback from the interconnect may be used to adjust the voltage supply to save power. Power consumption may be reduced by scaling supply voltage until eye mask and/or bit error rate thresholds are passed. Eye monitors and/or bit error rate monitoring and/or other proxies for eye quality may be used to provide feedback to adjust the dynamic voltage across interfaces.

Voltage scaling and bias scaling may be a dynamic process. For example, the bit error rate and/or eye openings and/or some other property may be used to adjust voltage and/or bias until a performance threshold is reached. When the performance threshold is reached, the equalization may be adjusted. This process may be continued until the voltage may be minimized and the equalization may be maximized.

When moving from a lower modulation scheme to a higher modulation scheme (e.g., when moving from NRZ to PAM-4), the power usage may be increased. However, when adequate margin is available for PAM-4, then moving from a lower modulation scheme to a higher modulation scheme may not involve an increase in power usage e.g., when the channel conditions allow for the higher modulation scheme.

The D2D interconnect may leverage link training (e.g., foreground and background). Link training may happen on power-up and may be adapted using background techniques. Adaptation may rely on compact sensing and feedback protocol. A sideband (e.g., a side channel) may be used to handle adaptation. A side channel may be a physical layer which may occupy a small fraction of the available channel capacity and may not interfere with a main channel. Link training may occur in the background and may be power-efficient, which implies simplicity and link stability where high bandwidths are involved. Background link training may achieve efficiency by duty cycling with a periodicity sufficient to track process, voltage, temperature (PVT) and channel drift.

The D2D interconnect may implement duty cycling for energy efficiency at different data rates. For low data rates, the PHY may be capable of duty cycling to achieve energy efficiency at low speeds. Synchronization of the duty period between transmit and receive may be achieved through sideband communication. High-speed power up/down capability may be implemented in a compact form factor. The links may be powered down dynamically when the links are not being used.

The D2D interconnect may facilitate modulation as a tradeoff. The D2D interconnect may support one or more of non-return-to-zero (NRZ) modulation or pulse amplitude modulation 4 (PAM4) modulation. Supporting NRZ and PAM4 modulation may support beachfront density as well as gearbox-free native compatibility with e.g., Institute of Electrical and Electronics Engineers (IEEE) 802.3bs and peripheral component interconnect express (PCIe) Generation 6. PAM4 modulation may involve complexity and energy penalties, in exchange for doubling the signal density. Timing recovery may be used to tighten the eye masks for each modulation. In addition or alternatively, higher order modulation may be used. Higher order modulation may be modulation that is higher than PAM4, e.g., PAM6, PAM8, PAM16, or the like.

The D2D interconnect may support different wiring configurations. The D2D interconnect may be one or more of single ended or differential. Abundant wiring may be leveraged to support differential, single-ended and multi-lane vectoring. To enable higher-speed links, several alternatives may supported, each backed by different levels of digital circuitry. For example, the alternatives may include: (i) single-ended without crosstalk control, (ii) single-ended with crosstalk control, (iii) differential without crosstalk control, and/or (iv) differential with crosstalk control.

The D2D device may implement enhancements to the voltage swing. Based on reasonable assumptions about circuit noise, signal to noise ratio (SNR), and link loss budget for a 1 mm connection, the minimum output swing for 1E-15 performance on a PAM4 6 Gbps signal may be in the 100 mV range. Many existing standards such as AIB and HBM3 may run at 6 Gbps link rates. An NRZ signal may use swing of about 20 mV. UCIe 2.0 may target a swing of 400 mV on links up to 10 mm. Since swing may directly impact choice of rails, available headroom as well as digital circuit power dissipation, chiplet interconnects may use an adaptive approach in this area.

Examples of the present disclosure will be explained with reference to the accompanying drawings.

The D2D device may implement enhancements to the symbol timing recovery and circuit bandwidth.

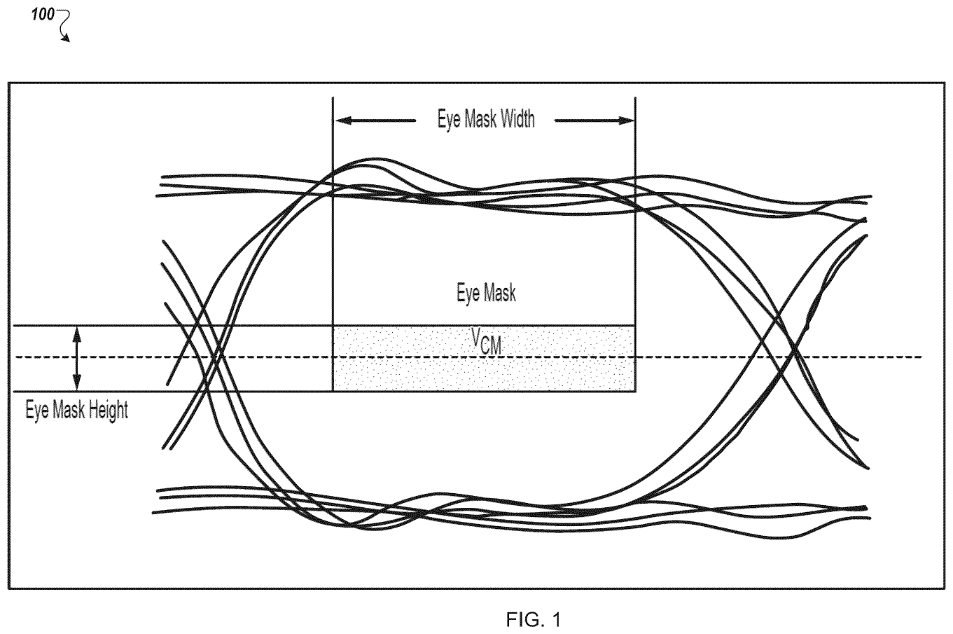

In some examples, FIG. 1 illustrates a compliance eye mask 100. The eye mask width and the eye mask height are illustrated. In addition, V_{cm} is shown. For example, for this eye mask, the standard used may be an AIB standard. The voltage swing may be about 400 mV. The bandwidth per lane may be about 6 Gbps. Therefore, the voltage swing may not be optimized for this particular eye mask. Using dynamic voltage scaling and bias scaling may increase the throughput and energy efficiency.

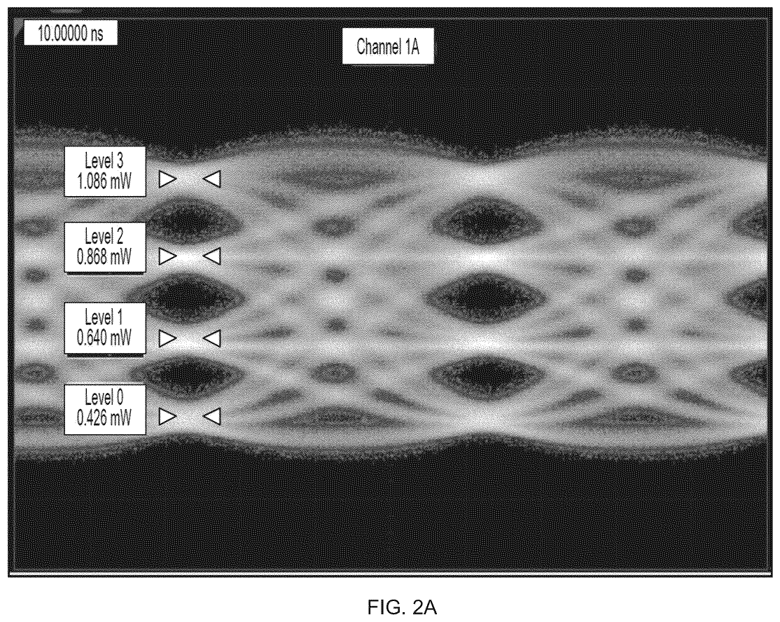

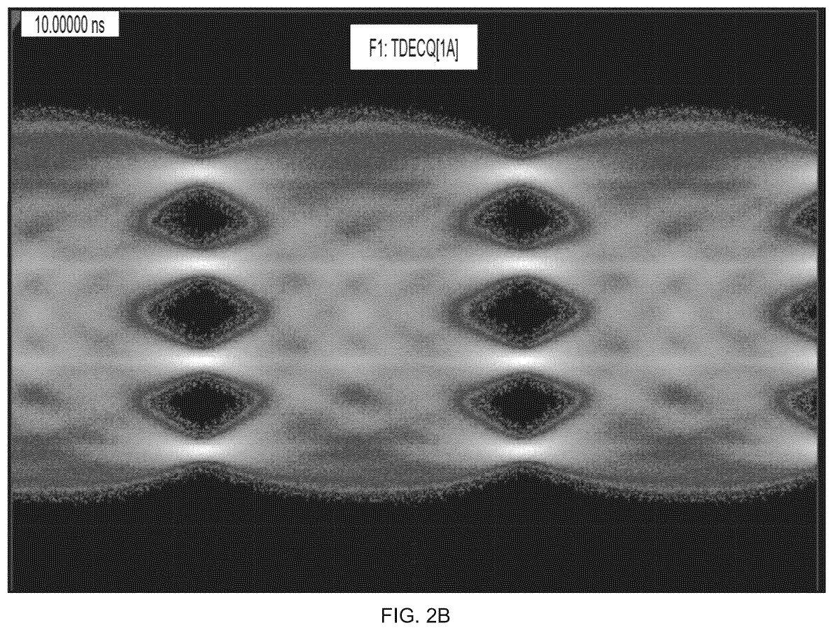

FIGS. 2A and 2B show optical eye diagrams of 800G optical transceivers with link BER of 1E-11 on 100 Gbps per lane. Eye masks stipulated in standards such as AIB may include flexibility in terms of timing and margins. This may create a burden on bandwidth (rise time and settling time) as well as swing, which ripples to circuit design and power consumption. This approach may also be predicated on the absence of advanced analog and digital signal processing techniques, data converters, and other factors in high performance transceivers. There may be more than one order of magnitude difference between the speeds corresponding to the systems in FIG. 1 and FIGS. 2A and 2B, which represent different options in the interconnect space.

As illustrated in FIG. 2A, for a channel, four difference levels may be shown. Level 0 may have a power of 0.426 mW. Level 1 may have a power of 0.640 mW. Level 2 may have a power of 0.868 mW. Level 3 may have a power of 1.086 mW. Therefore, 4 different levels may be provided to provide an 800 Gbps optical transceiver with a link BER of 1E-11 on 100 Gbps per lane. FIG. 2B illustrates another optical eye diagram which may provide an 800 Gbps optical transceiver with a link BER of 1E-11 on 100 Gbps per lane.

Therefore, FIG. 1 may be focused on simplicity and density while FIGS. 2A and 2B may be focused on throughput and power efficiency. Some contributors to eye mask include: broadband circuit and thermal noise; jitter from transmit and receive; inter-symbol interference; symbol timing phase accuracy and tracking bandwidth. For example, die-to-die links may not include tracking of sample phase and symbol timing phase adjustment when no feedback is provided to perform this tracking.

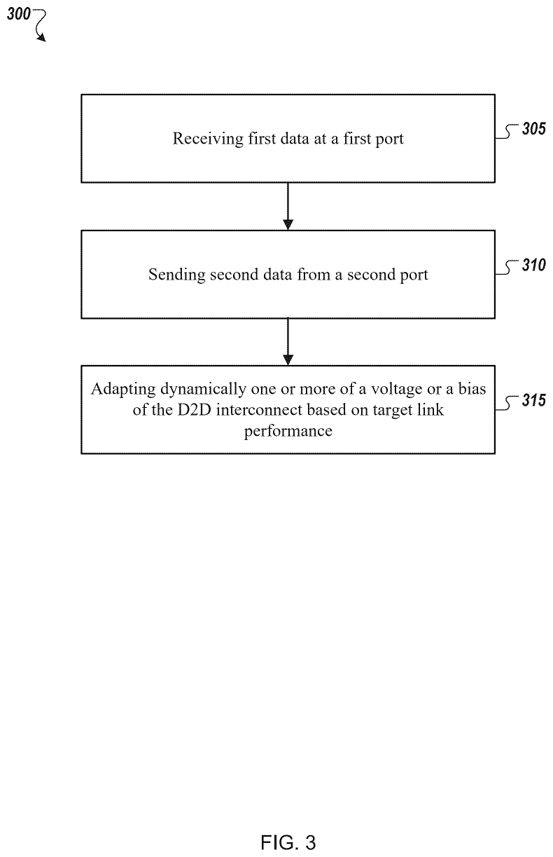

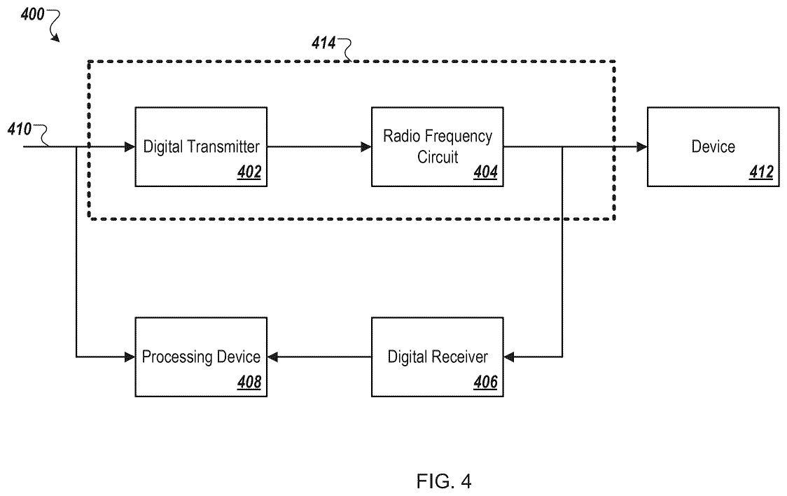

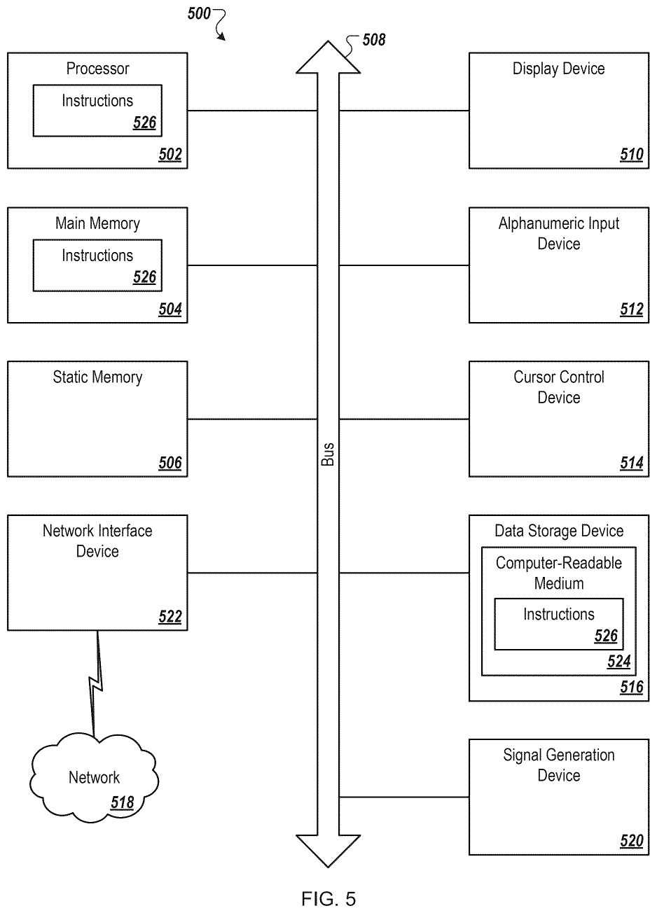

FIG. 3 illustrates a process flow of an example method 300 for D2D interconnects, in accordance with at least one example described in the present disclosure. The method 300 may be arranged in accordance with at least one example described in the present disclosure. The method 300 may be performed by processing logic that may include hardware (circuitry, dedicated logic, etc.), software (such as is run on a computer system or a dedicated machine), or a combination of both, which processing logic may be included in the processing device 502 of FIG. 5, the communication system 400 of FIG. 4, or another device, combination of devices, or systems.

The method 300 may begin at block 305 where the processing logic may receive, at a die-to-die interconnect, first data at a first port.

At block 310, the processing logic may send, from the D2D interconnect, second data from a second port.

At block 315, the processing logic may adapt dynamically one or more of a voltage or a bias of the D2D interconnect based on target link performance.

A link reach of the D2D interconnect may be from about 100 μm to about 50 cm. The processing logic may use a UCIe standard. The processing logic may maximize, at the D2D interconnect, one or more of energy efficiency, beachfront density, or throughput density. The processing logic may determine an eye mask for the D2D interconnect based on one or more of error correction, latency, or energy efficiency. The processing logic may determine a link capability of the D2D interconnect using one or more of sensing or handshaking. The processing logic may adapt link training of the D2D interconnect using a side channel. The processing logic may use duty cycling. The processing logic may use one or more of non-return-to-zero (NRZ) modulation, pulse amplitude modulation 4 (PAM4) modulation, or higher order modulation. The D2D interconnect may be one or more of single-ended or differential.

Modifications, additions, or omissions may be made to the method 300 without departing from the scope of the present disclosure. For example, in some examples, the method 300 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 4 illustrates a block diagram of an example communication system 400 operable for a D2D interconnect in accordance with at least one example described in the present disclosure. The communication system 400 may include a digital transmitter 402, a radio frequency circuit 404, a device 412, a digital receiver 406, and a processing device 408. The digital receiver 406 and the processing device 408 may receive a baseband signal via connection 410. A transceiver 414 may comprise the digital transmitter 402 and the radio frequency circuit 404.

In some examples, the communication system 400 may include a system of devices that may communicate with one another via a wired or wireline connection. For example, a wired connection in the communication system 400 may include one or more Ethernet cables, one or more fiber-optic cables, and/or other similar wired communication mediums. Alternatively, or additionally, the communication system 400 may include a system of devices that may communicate via one or more wireless connections. For example, the communication system 400 may include one or more devices that may transmit and/or receive radio waves, microwaves, ultrasonic waves, optical waves, electromagnetic induction, and/or similar wireless communications. Alternatively, or additionally, the communication system 400 may include combinations of wireless and/or wired connections. In these and other examples, the communication system 400 may include one or more devices that may obtain a baseband signal, perform one or more operations to the baseband signal to generate a modified baseband signal, and transmit the modified baseband signal, such as to one or more loads.

In some examples, the communication system 400 may include one or more communication channels that may communicatively couple systems and/or devices included in the communication system 400. For example, the transceiver 414 may be communicatively coupled to the device 412.

In some examples, the transceiver 414 may obtain a baseband signal. For example, as described herein, the transceiver 414 may generate a baseband signal and/or receive a baseband signal from another device. In some examples, the transceiver 414 may transmit the baseband signal. For example, upon obtaining the baseband signal, the transceiver 414 may transmit the baseband signal to a separate device, such as the device 412. Alternatively, or additionally, the transceiver 414 may modify, condition, and/or transform the baseband signal in advance of transmitting the baseband signal. For example, the transceiver 414 may include a quadrature up-converter and/or a digital to analog converter (DAC) that may modify the baseband signal. Alternatively, or additionally, the transceiver 414 may include a direct radio frequency (RF) sampling converter that may modify the baseband signal.

In some examples, the digital transmitter 402 may obtain a baseband signal via connection 410. In some examples, the digital transmitter 402 may up-convert the baseband signal. For example, the digital transmitter 402 may include a quadrature up-converter to apply to the baseband signal. In some examples, the digital transmitter 402 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 402.

In some examples, the transceiver 414 may include one or more subcomponents that may be used in preparing the baseband signal and/or transmitting the baseband signal. For example, the transceiver 414 may include an RF front end (e.g., in a wireless environment) which may include a power amplifier (PA), a digital transmitter (e.g., 702), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 404) of the transceiver 414 may be synchronized with the resource controller via the S-plane device, which may contribute to high-accuracy timing with respect to a reference clock.

In some examples, the transceiver 414 may obtain the baseband signal for transmission. For example, the transceiver 414 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 414 may generate a baseband signal for transmission. In these and other examples, the transceiver 414 may transmit the baseband signal to another device, such as the device 412.

In some examples, the device 412 may receive a transmission from the transceiver 414. For example, the transceiver 414 may transmit a baseband signal to the device 412.

In some examples, the radio frequency circuit 404 may transmit the digital signal received from the digital transmitter 402. In some examples, the radio frequency circuit 404 may transmit the digital signal to the device 412 and/or the digital receiver 406. In some examples, the digital receiver 406 may receive a digital signal from the RF circuit and/or send a digital signal to the processing device 408.

In some examples, the processing device 408 may be a standalone device or system, as illustrated. Alternatively, or additionally, the processing device 408 may be a component of another device and/or system. For example, in some examples, the processing device 408 may be included in the transceiver 414. In instances in which the processing device 408 is a standalone device or system, the processing device 408 may communicate with additional devices and/or systems remote from the processing device 408, such as the transceiver 414 and/or the device 412. For example, the processing device 408 may send and/or receive transmissions from the transceiver 414 and/or the device 412. In some examples, the processing device 408 may be combined with other elements of the communication system 400.

FIG. 5 illustrates a diagrammatic representation of a machine in the example form of a computing device 500 within which a set of instructions, for causing the machine to perform any one or more of the methods discussed herein, may be executed. The computing device 500 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 500 includes a processing device (e.g., a processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

Processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an ASIC, a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one example, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 524 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a die-to-die (D2D) interconnect operable to receive first data at a first port and transmit second data from a second port,
wherein one or more of a voltage or a bias of the D2D interconnect is dynamically adapted based on target link performance.

2. The device of claim 1, wherein a link reach of the D2D interconnect is from about 100 μm to about 50 cm.

3. The device of claim 1, wherein the D2D interconnect is operable using a universal chiplet interconnect express (UCIe) standard.

4. The device of claim 1, wherein the D2D interconnect is operable to maximize one or more of energy efficiency, beachfront density, or throughput density.

5. The device of claim 1, wherein an eye mask of the D2D interconnect is based on one or more of error correction, latency, or energy efficiency.

6. The device of claim 1, wherein a link capability of the D2D interconnect is determined using one or more of sensing or handshaking.

7. The device of claim 1, wherein link training of the D2D interconnect is adapted using a side channel.

8. The device of claim 1, wherein the D2D interconnect is operable for duty cycling.

9. The device of claim 1, wherein the D2D interconnect is operable to support one or more of non-return-to-zero (NRZ) modulation, pulse amplitude modulation 4 (PAM4) modulation, or a higher order modulation.

10. The device of claim 1, wherein the D2D interconnect is one or more of single ended or differential.

11. A method, comprising:
receiving, at a die-to-die interconnect, first data at a first port;
sending, from the D2D interconnect, second data from a second port; and
adapting dynamically one or more of a voltage or a bias of the D2D interconnect based on target link performance.

12. The method of claim 11, wherein a link reach of the D2D interconnect is from about 100 μm to about 50 cm.

13. The method of claim 11, wherein the D2D interconnect is operable using a universal chiplet interconnect express (UCIe) standard.

14. The method of claim 11, further comprising maximizing, at the D2D interconnect, one or more of energy efficiency, beachfront density, or throughput density.

15. The method of claim 11, further comprising determining an eye mask for the D2D interconnect based on one or more of error correction, latency, or energy efficiency.

16. The method of claim 11, further comprising determining a link capability of the D2D interconnect using one or more of sensing or handshaking.

17. The method of claim 11, further comprising adapting link training of the D2D interconnect using a side channel.

18. The method of claim 11, further comprising using duty cycling.

19. The method of claim 11, further comprising using one or more of non-return-to-zero (NRZ) modulation, pulse amplitude modulation 4 (PAM4) modulation, or a higher-order modulation.

20. The method of claim 11, wherein the D2D interconnect is one or more of single ended or differential.
